(19) United States
(12) Patent Application Publication
(10) Pub. No.: US 2025/0102999 A1
(43) Pub. Date: Mar. 27, 2025

(54) IMAGE FORMING APPARATUS

(71) Applicant: FUJIFILM Business Innovation Corp., Tokyo (JP)

(72) Inventors: Go MIURA, Kanagawa (JP); Yutaka KIUCHI, Kanagawa (JP); Arichika TANAKA, Kanagawa (JP)

(73) Assignee: FUJIFILM Business Innovation Corp., Tokyo (JP)

(21) Appl. No.: 18/582,165

(22) Filed: Feb. 20, 2024

(30) Foreign Application Priority Data
Sep. 22, 2023 (JP) 2023-159077

(51) Int. Cl. G03G 21/16; G03G 15/00

(52) U.S. Cl. CPC G03G 21/1671; G03G 15/751; G03G 21/1647

(57) ABSTRACT

An image forming apparatus includes: a photoconductor; at least one holding member including a handhold and rotatably holding a shaft of the photoconductor; and a receiving member disposed at an apparatus body to allow the at least one holding member to be attachable thereto and removable therefrom.

### CROSS-REFERENCE TO RELATED APPLICATIONS

This application is based on and claims priority under 35 USC 119 from Japanese Patent Application No. 2023-159077 filed Sep. 22, 2023.

### BACKGROUND

### (i) Technical Field

The present disclosure relates to an image forming apparatus.

### (ii) Related Art

Japanese Unexamined Patent Application Publication No. 62-254159 discloses a color image forming apparatus that forms color images based on image information obtained by breaking down a document into multiple pieces by color, with multiple optical systems and image forming portions including photoconductor drums. In the color image forming apparatus, each of the multiple optical systems and a corresponding one of the image forming portions form a single module to be simultaneously or individually attachable or removable, and each module is attachable and removable while leaving a drum shaft of the corresponding photoconductor drum rotatably fixed to an apparatus body.

Japanese Unexamined Patent Application Publication No. 10-214015 discloses an electrophotographic apparatus that includes a photoconductor support drum installed to be drawable from a printing mechanism unit, and a photoconductor attachable to and removable from a photoconductor support surface of the drum. The electrophotographic apparatus includes a front frame and a rear frame forming a part of the printing mechanism unit, an opening in the front frame and having a dimension greater than an outer diameter of the drum, a front support member that rotatably holds a front rotation shaft protruding from a front side surface of the drum and that is attachable to and removable from the opening, a positioner that rotatably holds a rear rotation shaft protruding from a rear side surface of the drum and removably fitted to a holder portion disposed at the rear frame, a guide member including a guide portion substantially parallel to the rotation shaft of the drum, the guide member being supported between the front frame and the rear frame, and a drum rear support member that supports the positioner and that is supported to be movable along the guide portion of the guide member.

### SUMMARY

Aspects of non-limiting embodiments of the present disclosure relate to a structure including an apparatus body that rotatably supports a photoconductor with a holding member and a receiving member interposed in between. In the structure, the photoconductor is more easily removable from the apparatus body than in a structure where the whole receiving member is removed from the apparatus body for replacement of the photoconductor.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus that includes: a photoconductor; at least one holding member including a handhold and rotatably holding a shaft of the photoconductor; and a receiving member disposed at an apparatus body to allow the at least one holding member to be attachable thereto and removable therefrom.

### BRIEF DESCRIPTION OF THE DRAWINGS

Exemplary embodiments of the present disclosure will be described in detail based on the following figures, wherein:

FIG. 1 is a schematic view of an image forming apparatus according to an exemplary embodiment of the present disclosure;

FIG. 2 is a perspective view of an apparatus body of the image forming apparatus in FIG. 1 from which an image forming unit is pulled out;

FIG. 3 is a cross-sectional view of a holder at the rear in an apparatus depth direction in FIG. 2, taken in an apparatus width direction;

FIG. 4 is an enlarged plan view of a portion indicated with arrow 4X in FIG. 2;

FIG. 5 is an enlarged plan view of a portion indicated with arrow 5X in FIG. 2;

FIG. 6 is a perspective view of the image forming unit in FIG. 2 from which a photoconductor drum is removed; and

FIG. 7 is a front view of a holder viewed in an axial direction of a photoconductor drum.

### DETAILED DESCRIPTION

An example of an image forming apparatus according to an exemplary embodiment of the present disclosure is described.

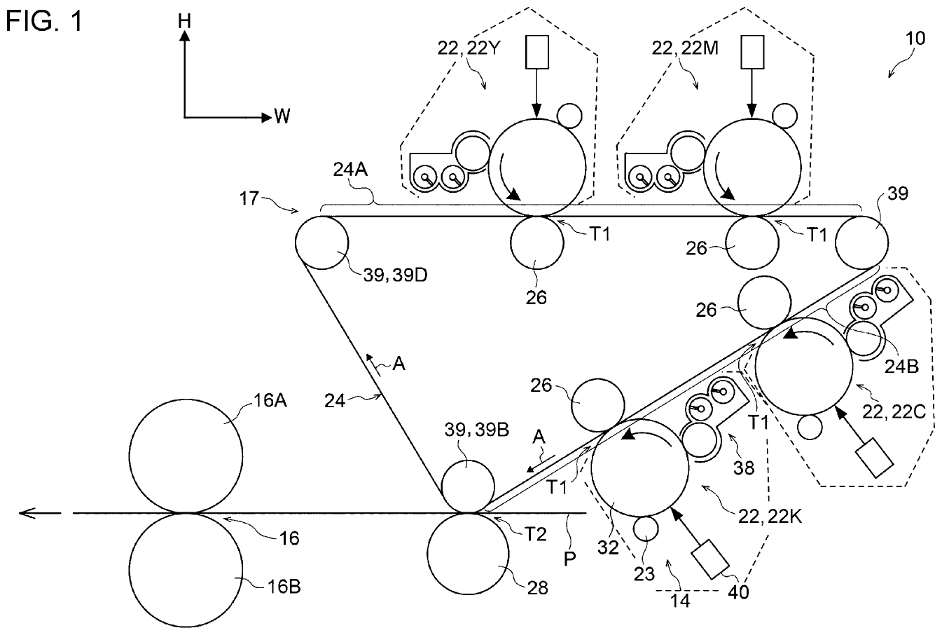

With reference to FIGS. 1 to 7, a fixing device and an image forming apparatus according to an exemplary embodiment of the present disclosure are described. Throughout the drawings, arrow H indicates an apparatus height direction (vertical direction), arrow W indicates an apparatus width direction (horizontal direction), and arrow D indicates an apparatus depth direction (horizontal direction).

Components denoted with the same reference signs throughout the drawings indicate the same or similar components. Redundant description and reference signs in one or more exemplary embodiments described below may be omitted. The drawings used to describe the following description are schematic, and, for example, the actual dimensional relationship between components or the actual ratios of the components may not be necessarily reflected on the dimensional relationship between components or the ratios of the components in the drawings. For example, the dimensional relationship between components and the ratios of the components may not be necessarily reflected on the dimensional relationship between components and the ratios of the components between multiple drawings.

### Image Forming Apparatus 10

A structure of an image forming apparatus 10 according to an exemplary embodiment is described. FIG. 1 is a schematic diagram of the image forming apparatus 10 according to the present exemplary embodiment. The image forming apparatus 10 is an image forming apparatus that forms images with multiple colors, for example, a full-color printer for high-quality commercial printing.

The image forming apparatus 10 is, for example, an image forming apparatus for a wide medium to cope with a recording medium P with a width exceeding the width for B3 in the short-edge feed orientation (that is, a width exceeding 364 mm). Instead, the image forming apparatus 10 may cope with a recording medium P of a size greater than or equal to 420 mm in the A2 short-edge feed orientation, and smaller than or equal to 1456 mm in the B0 long-edge feed orientation.

The image forming apparatus 10 illustrated in FIG. 1 is an example of an image forming apparatus that forms images on recording media. More specifically, the image forming apparatus 10 is an electrophotographic image forming apparatus that forms toner images (an example of images) on recording media P. More specifically, the image forming apparatus 10 includes an image forming portion 14 and a fixing device 16. Hereafter, components (the image forming portion 14 and the fixing device 16) of the image forming apparatus 10 are described.

### Image Forming Portion 14

The image forming portion 14 has a function of forming toner images on recording media P. More specifically, the image forming portion 14 includes multiple image forming units 22 and a transfer device 17.

The multiple image forming units 22 illustrated in FIG. 1 form toner images of different colors. The present exemplary embodiment includes the image forming units 22 for four colors of yellow (Y), magenta (M), cyan (C), and black (K). Y, M, C, and K following the reference signs in FIG. 1 denote components with the reference signs corresponding to their colors.

The image forming units 22 for different colors have the same structure except for using different toner. Thus, among the image forming units 22 for different colors, components of the image forming unit 22K are denoted with references signs in FIG. 1.

More specifically, the image forming units 22 for different colors each include a photoconductor drum 32 that rotates in one direction (for example, a counterclockwise direction in FIG. 1). The photoconductor drum 32 is an example of an image carrier. The image forming units 22 for different colors each further include a charging device 23, an exposure device 40, and a development device 38.

In each of the image forming units 22 for different colors, the charging device 23 charges the photoconductor drum 32 with electricity. The exposure device 40 exposes the photoconductor drum 32 charged by the charging device 23 with electricity to light to form an electrostatic latent image on the photoconductor drum 32. The development device 38 develops an electrostatic latent image formed by the exposure device 40 on the photoconductor drum 32 to form a toner image.

The photoconductor drum 32 rotates while holding the electrostatic latent image formed in the above manner on the outer circumference to transport the electrostatic latent image to the development device 38.

The transfer device 17 illustrated in FIG. 1 is a device that transfers toner images formed on the image forming units 22 to a recording medium P. More specifically, the transfer device 17 first-transfers the toner images on the photoconductor drums 32 for different colors to be superposed one on another on a transfer belt 24 serving as an intermediate transfer body, and second-transfers the superposed toner images to the recording medium P. More specifically, as illustrated in FIG. 1, the transfer device 17 includes a transfer belt 24, first transfer rollers 26, and a second transfer roller 28.

The first transfer rollers 26 are rollers that transfer toner images on the photoconductor drums 32 for different colors to the transfer belt 24 at first transfer positions T1 between the photoconductor drums 32 and the first transfer rollers 26. In the present exemplary embodiment, a first-transfer electric field is applied to each first transfer roller 26 and the corresponding photoconductor drum 32 to transfer the toner image formed on the photoconductor drum 32 to the transfer belt 24 at the corresponding first transfer position T1.

The toner images are transferred from the photoconductor drums 32 for different colors to the outer circumferential surface of the transfer belt 24. As illustrated in FIG. 1, the transfer belt 24 has a loop shape, and is wound around multiple rollers 39 to have its position fixed.

The transfer belt 24 is rotated in a direction of arrow A by, for example, a driving roller 39D included in the multiple rollers 39, being driven to rotate by a driving portion (not illustrated). Of the multiple rollers 39, a roller 39B illustrated in FIG. 1 is an opposite roller 39B that faces the second transfer roller 28.

The second transfer roller 28 is a roller that transfers the toner images transferred to the transfer belt 24 to a recording medium P at a second transfer position T2 between the opposite roller 39B and the second transfer roller 28. In the present exemplary embodiment, a second-transfer electric field is applied between the opposite roller 39B and the second transfer roller 28 to transfer the toner images transferred to the transfer belt 24 onto the recording medium P at the second transfer position T2.

As illustrated in FIG. 1, the transfer belt 24 serving as an example of a transfer member according to the present exemplary embodiment includes a horizontal portion 24A extending in the horizontal direction, and an inclined portion 24B extending obliquely with respect to the vertical direction.

In the image forming apparatus 10 according to the present exemplary embodiment, as illustrated in FIG. 1, the image forming units 22Y and 22M are disposed above the transfer belt 24. More specifically, the image forming units 22Y and 22M are disposed at a distance apart from each other along the horizontal portion 24A of the transfer belt 24.

In the image forming apparatus 10 according to the present exemplary embodiment, as illustrated in FIG. 1, the image forming units 22C and 22K are disposed below the transfer belt 24. More specifically, the image forming units 22C and 22K are disposed at a distance apart from each other along the inclined portion 24B of the transfer belt 24.

### Fixing Device 16

The fixing device 16 illustrated in FIG. 1 is a device that fixes the toner images transferred to the recording medium P by the second transfer roller 28 to the recording medium P. More specifically, as illustrated in FIG. 1, the fixing device 16 includes a heating roller 16A serving as a heating member, and a pressing roller 16B serving as a pressing member. The fixing device 16 heats and presses the recording medium P with the heating roller 16A and the pressing roller 16B to fix the toner images formed on a recording medium P to the recording medium P.

The image forming units 22 serving as related portions of the present disclosure are described in detail below. Hereafter, the image forming unit 22K is described as an example, but K to be added to each reference sign may be omitted as appropriate.

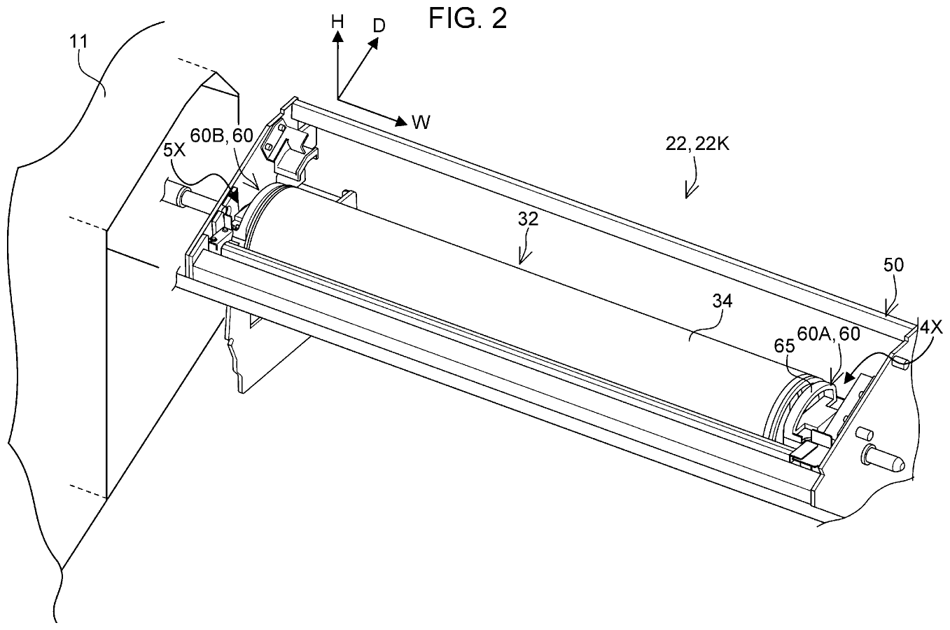

The image forming unit 22 includes a frame 50 serving as an example of a receiving member. As illustrated in FIG. 2, the frame 50 is installed in an apparatus body 11 to be capable of being pulled out of the apparatus body 11 in the apparatus depth direction. More specifically, a slide mechanism (not illustrated) is installed between the frame 50 and the apparatus body 11. The slide mechanism is capable of pulling the frame 50 out from the apparatus body 11 and pushing the frame 50 into the apparatus body 11 in an apparatus depth direction.

The photoconductor drum 32 serving as an example of a photoconductor, the charging device 23, and the exposure device 40, and the development device 38 are attached to the frame 50.

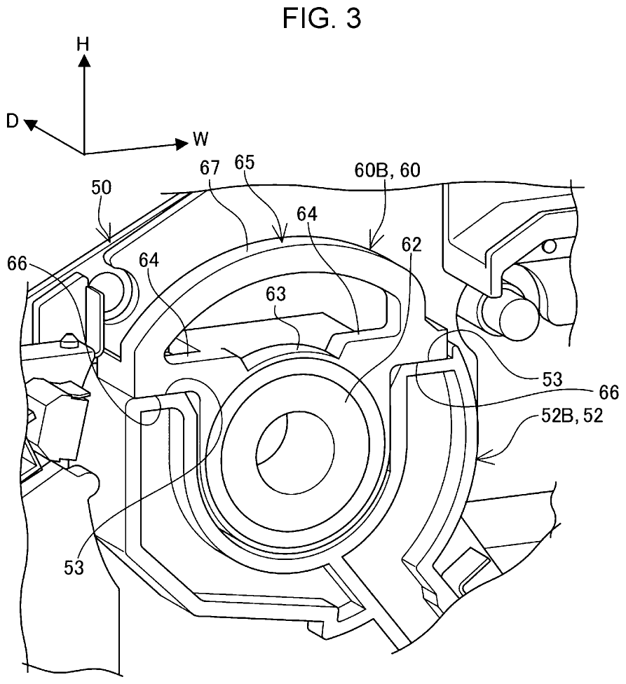

As illustrated in FIG. 2 and FIG. 3, the photoconductor drum 32 is attached to the frame 50 with holders 60 serving as examples of holding members interposed in between.

The holders 60 have a function of rotatably holding a shaft 33 of the photoconductor drum 32. More specifically, as illustrated in FIG. 3, the holders 60 each include a bearing 62, and the holders 60 hold the shaft 33 of the photoconductor drum 32 with the bearings 62 interposed in between. The bearings 62 allow the shaft 33 of the photoconductor drum 32 to be rotatably held by the holders 60. In the present exemplary embodiment, as illustrated in FIG. 2, both end portions of the shaft 33 of the photoconductor drum 32 are held by a pair of holders 60. Hereafter, a first end of the shaft 33 is denoted with 33A, and a second end of the shaft 33 is denoted with 33B. Similarly, a holder that holds the first end 33A of the shaft 33 of the photoconductor drum 32 is denoted with 60A, and a holder that holds the second end 33B of the shaft 33 of the photoconductor drum 32 is denoted with 60B. The same components between the holder 60A and the holder 60B are described as components of the holder 60.

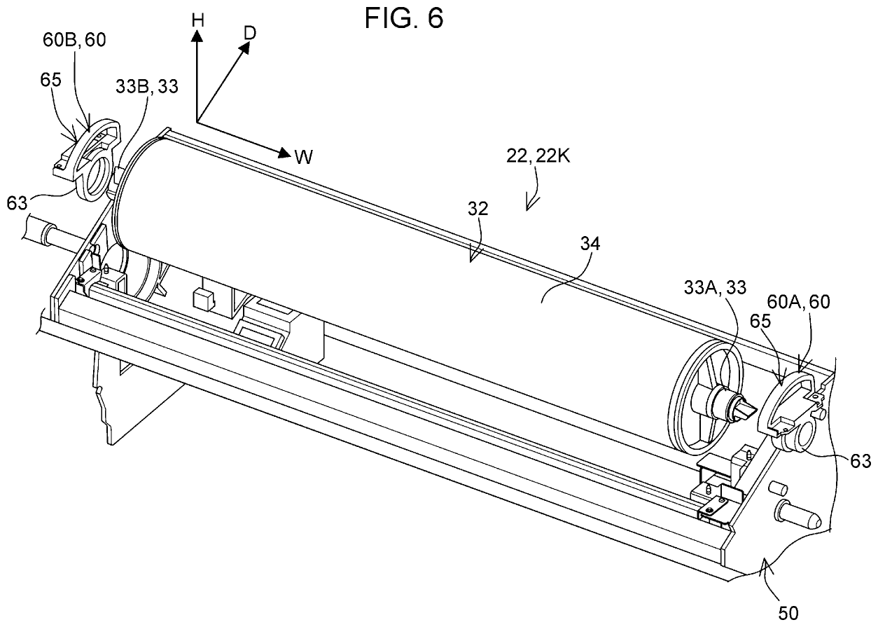

As illustrated in FIG. 6, the holders 60 are removable from the shaft 33 of the photoconductor drum 32. More specifically, the holders 60 are removed from the photoconductor drum 32 by pulling the shaft 33 of the photoconductor drum 32 out of the bearings 62 of the holders 60.

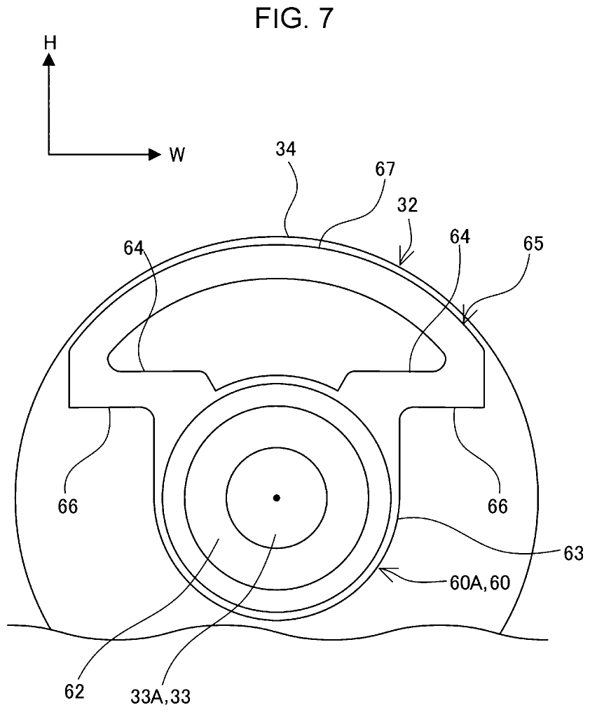

Each holder 60 includes a mount portion 63 to which the bearing 62 is attached, a pair of flanges 64 protruding sideways from an upper portion of the mount portion 63, and a handhold 65 extending from an end portion of one of the flanges 64 to an end portion of the other flange 64. The handhold 65 extends to be curved in an arc shape from an end portion of one of the flanges 64 to an end portion of the other flange 64 while leaving a space between itself and the mount portion 63. As illustrated in FIG. 7, the handhold 65 has its outer circumference curved along the outer circumference of the photoconductor drum 32 when the photoconductor drum 32 is viewed in the axial direction. More specifically, the handhold 65 has an outer circumferential surface 67 that is curved along an outer circumferential surface 34 of the photoconductor drum 32 when the photoconductor drum 32 is viewed in the axial direction.

Each holder 60 is removably attached to the frame 50. More specifically, as illustrated in FIG. 3, each holder 60 is removably attached to a corresponding support portion 52 of the frame 50 in one direction crossing the shaft 33 of the photoconductor drum 32. More specifically, each holder 60 is attached to the corresponding support portion 52 from above, and removed from the support portion 52 by being lifted up from the support portion 52. In other words, in the present exemplary embodiment, the direction in which each holder 60 is attached to and removed from the frame 50 is the apparatus height direction. In the present exemplary embodiment, each holder 60 is supported by the corresponding support portion 52 of the frame 50. More specifically, the holder 60A is supported by a support portion 52A, and the holder 60B is supported by a support portion 52B.

As illustrated in FIG. 3, each holder 60 and the corresponding support portion 52 have contact surfaces over which they come into contact with each other. Each support portion 52 supports the corresponding holder 60 at their contact surfaces. More specifically, upper surfaces 53 of each support portion 52 and the lower surfaces 66 of the flanges 64 of the corresponding holder 60 are contact surfaces that come into contact with each other, and lower surfaces 66 of each holder 60 are supported by the upper surfaces 53 of the corresponding support portion 52. When the lower surfaces 66 of each holder 60 are supported by the upper surfaces 53 of the corresponding support portion 52, the position of the holder 60 in the apparatus height direction is fixed. Specifically, the position of the photoconductor drum 32 in the apparatus height direction is fixed with the holders 60.

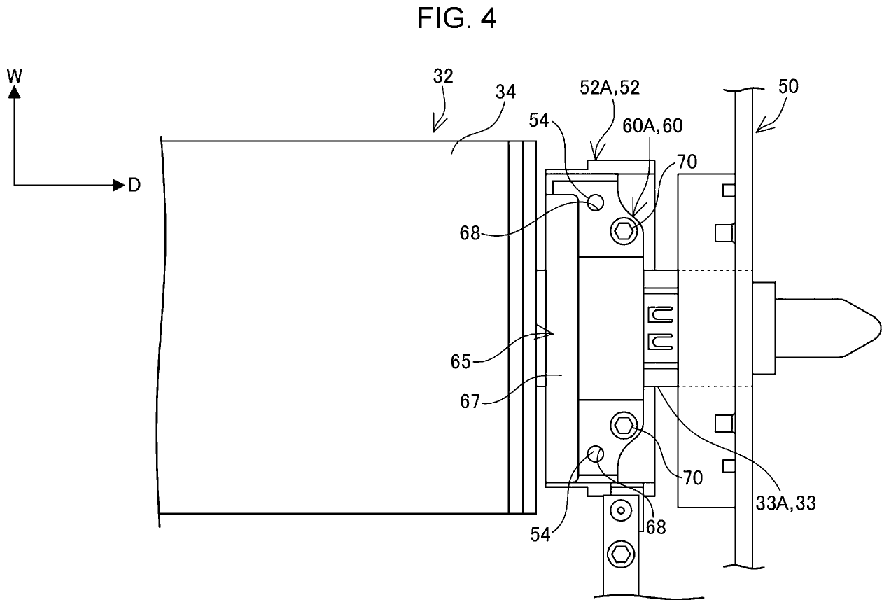

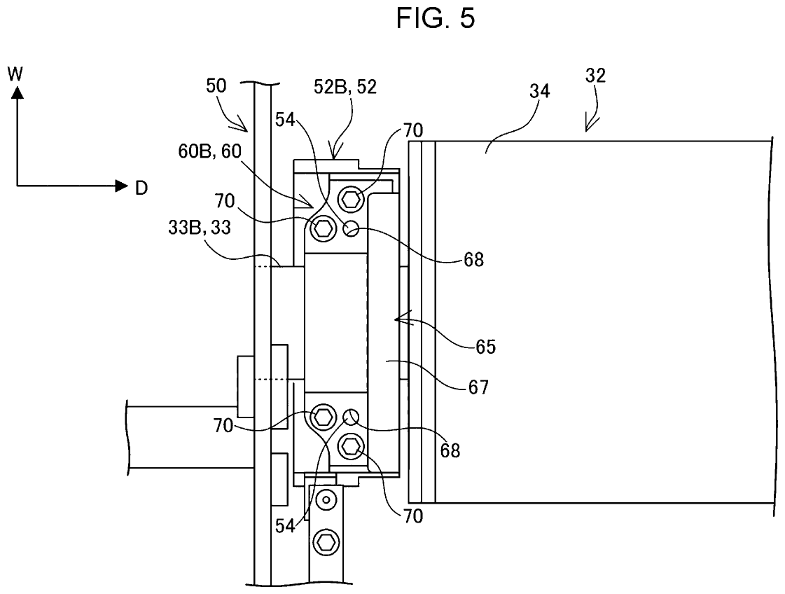

As illustrated in FIG. 4 and FIG. 5, each support portion 52 includes protrusions 54, and each holder 60 includes through-holes 68 serving as examples of recesses to which the protrusions 54 fit. More specifically, the protrusions 54 are disposed on the upper surfaces 53 of each support portion 52, and protrude upward from the upper surfaces 53. The through-holes 68 are formed in the flanges 64 of each holder 60, and extend through the flanges 64 in the thickness direction to be open in the lower surfaces 66. When the protrusions 54 fit to the through-holes 68, the position of the holder 60 in the apparatus width direction and the apparatus depth direction is fixed. Specifically, the position of the photoconductor drum 32 in the apparatus width direction and the apparatus depth direction is fixed with the holders 60. In the present exemplary embodiment, the direction in which the protrusions 54 and the through-holes 68 fit to each other is a direction parallel to the direction in which the holders 60 are attached to and removed from the frame 50.

As illustrated in FIG. 4 and FIG. 5, the frame 50 and each holder 60 are fastened by fastening members 70 at portions that come into contact with each other. More specifically, the flanges 64 of each holder 60 are fastened to the corresponding support portion 52 with screw members serving as the fastening members 70. More specifically, each holder 60 is fastened to the corresponding support portion 52 by screwing screws into female screws formed in the upper surfaces 53 of the support portion 52 through holes formed in the flanges 64 of the holder 60. The fastening direction of the fastening members 70 is a direction parallel to the direction in which the holder 60 is attached to and removed from the frame 50.

An operation of replacing the photoconductor drum 32 is described now.

The image forming unit 22 is pulled out from the apparatus body 11. Subsequently, the fastening members 70 that fasten the holders 60A and 60B to the support portions 52A and 52B are removed. Thereafter, the handholds 65 of the holders 60A and 60B that hold both ends 33A and 33B of the shaft 33 of the photoconductor drum 32 are gripped to lift the photoconductor drum 32 upward. Thus, the photoconductor drum 32 is detached from the frame 50. In the image forming unit 22 according to the present exemplary embodiment, the photoconductor drum 32 is removable from the frame 50 together with the holders 60 without removing the charging device 23, the exposure device 40, and the development device 38 from the frame 50.

Subsequently, the holders 60A and 60B are removed from both ends 33A and 33B of the shaft 33 of the photoconductor drum 32 to be replaced (refer to FIG. 6), and the removed holders 60A and 60B are respectively attached to both ends 33A and 33B of the shaft 33 of a new photoconductor drum 32.

Subsequently, the handholds 65 of the holders 60A and 60B are gripped to lift up the photoconductor drum 32, and brought to the support portions 52A and 52B from above the frame 50 to allow the support portions 52A and 52B to support the holders 60A and 60B. The holders 60A and 60B are then fastened to the support portions 52A and 52B with the fastening members 70.

The image forming unit 22 is then pushed into the apparatus body 11 to finish the operation of replacing the photoconductor drum 32.

The operation of the present exemplary embodiment is described below.

In the image forming apparatus 10, as described above, the photoconductor drum 32 is replaceable by attaching and detaching the holders 60 to and from the frame 50 while gripping the handholds 65. Specifically, in the image forming apparatus 10, the photoconductor drum 32 is more easily removable from the apparatus body 11 than in a structure where the whole frame 50 is removed from the apparatus body 11 during replacement of the photoconductor drum 32.

In the image forming apparatus 10, the holders 60 are removably attached to the frame in one direction. Thus, the mechanism of attaching or removing the holders 60 to and from the support portions 52 of the frame 50 is simpler than a structure in which each holder 60 is removably attached in multiple directions.

In the image forming apparatus 10, the holders 60 are attached to the frame 50 from above. Thus, the operation of attaching the holders 60 to the frame 50 is easier than in a case of attaching the holders 60 to the frame 50 from below.

In the image forming apparatus 10, both ends 33A and 33B of the shaft 33 of the photoconductor drum 32 are respectively held by the pair of holders 60A and 60B. Thus, the photoconductor drum 32 is held in better balance during replacement of the photoconductor drum 32 than in a case of simply holding the first end of the shaft 33 of the photoconductor drum 32 with the holder 60.

In the image forming apparatus 10, the holders 60 are removable from the shaft 33 of the photoconductor drum 32. Thus, the holders 60 are repeatedly usable after replacement of the photoconductor drum 32 unlike in a structure where the holders 60 are unremovable from the shaft 33 of the photoconductor drum 32.

In the image forming apparatus 10, the frame 50 and each holder 60 have contact surfaces that come into contact with each other, and the holder 60 is located at a predetermined position with respect to the frame 50 in a direction perpendicular to the contact surfaces with a simple operation of bringing the contact surfaces into contact with each other. Particularly, each holder 60 is located at a predetermined position with respect to the frame 50 in the apparatus height direction with a simple operation of supporting the lower surfaces 66 of the holder 60 including the contact surfaces on the upper surfaces 53 of the frame 50 including the contact surfaces. When the position of the holder 60 in the apparatus height direction is fixed, the position of the photoconductor drum 32 in the apparatus height direction is fixed. Specifically, the position of the photoconductor drum 32 in the apparatus height direction is fixed with a simple operation.

In the image forming apparatus 10, the frame 50 and each holder 60 are fastened to each other by the fastening members 70 at portions where they are in contact with each other. Thus, the accuracy of positioning each holder 60 with respect to the frame 50 is further improved than in a structure where the frame 50 and the holder 60 are fastened at portions where they are not in contact with each other.

In the image forming apparatus 10, the fastening direction of the fastening members 70 is a direction parallel to the direction in which the holders 60 are attached to and removed from the frame 50. Thus, the load imposed on the fastening members 70 is further reduceable than in a structure where the fastening direction of the fastening members 70 is inclined with respect to the direction in which the holders 60 are attached or removed.

In the image forming apparatus 10, the protrusions 54 of the frame 50 fit into the through-holes 68 of the holders 60 to fix the position of the holders 60 relative to the frame 50 in a direction perpendicular to the direction in which the protrusions 54 protrude. Thus, the position of each holder 60 relative to the frame 50 is fixed with a simple operation of adjusting the position of the holder 60 to allow the protrusions 54 of the frame 50 to fit into the through-holes 68 of the holder 60.

In the image forming apparatus 10, the direction in which the protrusions 54 of the frame 50 fit into the through-holes 68 of each holder 60 is a direction parallel to the direction in which the holder 60 is attached to and removed from the frame 50. Thus, the protrusions 54 are fitted into the through-holes 68 with an operation of attaching each holder 60 to the frame 50 unlike in a structure where a direction in which the protrusions 54 are fitted into the through-holes 68 is inclined with respect to the direction in which the holder 60 is attached or removed.

In the image forming apparatus 10, the handholds 65 are curved in an arc shape. Thus, the handholds 65 are more easily grippable than in a case of the handholds 65 having an angular shape. This structure facilitates an operation of removing the photoconductor drum 32 from the frame 50 while gripping the handholds 65 of the holders 60.

In the image forming apparatus 10, when the photoconductor drum 32 is viewed in the axial direction, the outer circumference of each handhold 65 is curved along the outer circumference of the photoconductor drum 32. This structure further improves the appearance around the photoconductor drum 32 than a structure where the outer circumference of each handhold 65 extends linearly beyond the outer circumference of the photoconductor drum 32. When the frame 50 is to be pulled out from the apparatus body 11, the handholds 65 of the holders 60 are on the trajectory of the photoconductor drum 32. Thus, interference between the holders 60 and other components of the apparatus body 11 is more likely to be reduced.

### Other Exemplary Embodiments

In the above exemplary embodiment, the protrusions 54 are disposed on the support portions 52 of the frame 50, and the through-holes 68 are formed in each holder 60. However, the present disclosure is not limited to this structure. For example, recesses to which the protrusions 54 fit may be formed in the lower surfaces 66 of each holder 60. This structure is capable of obtaining the same operations as those in the above exemplary embodiment. Alternatively, recesses may be formed in the upper surfaces 53 of the support portions 52 of the frame 50, and protrusions that are to fit to the recesses may be formed on the lower surfaces 66 of each holder 60. This structure is also capable of obtaining the same operations as those in the above exemplary embodiment.

In the above exemplary embodiment, the holders 60 are attached to the frame 50 from above, but the present disclosure is not limited to this structure. The holders 60 may be attached to the frame 50 sideways. For example, the image forming units 22K and 22C are arranged along the inclined portion 24B of the transfer belt 24. The holders 60 are attached to the frame 50 from above, and thus, the holders 60 are easily attachable to and removable from the frame 50. On the other hand, the image forming unit 22Y and 22M are arranged along the horizontal portion 24A of the transfer belt 24, and attaching the holders 60 to the frame 50 from above is difficult. In this case, the holders 60 are attached to the frame 50 sideways to facilitate attachment and removal of the holders 60 to and from the frame 50. To attach the holders 60 to the frame 50 sideways, the holders 60 may be attachable to the frame 50 sideways at an angle of 90 degrees. Alternatively, to attach the holders 60 to the frame 50 sideways, any of the charging device 23, the exposure device 40, and the development device 38 may be removed from the frame 50.

In the above exemplary embodiment, the holders 60A and 60B are respectively attached to both ends 33A and 33B of the shaft 33 of the photoconductor drum 32, but the present disclosure is not limited to this structure. The holder 60 may be simply attached to the first end of the shaft 33 of the photoconductor drum 32.

In the above exemplary embodiment, the holders 60A and 60B are respectively removable from both ends 33A and 33B of the shaft 33 of the photoconductor drum 32, but the present disclosure is not limited to this structure. For example, either one of the holders 60A and 60B may be unremovable, or the holders 60A and 60B may both be unremovable.

The present disclosure is not limited to the above exemplary embodiment, and may be modified, changed, or improved in various manners within the scope not departing from the gist of the present disclosure. For example, two or more of the above modifications may be combined as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An image forming apparatus comprising:
a photoconductor;
at least one holding member including a handhold and rotatably holding a shaft of the photoconductor; and
a receiving member disposed at an apparatus body to allow the at least one holding member to be attachable thereto and removable therefrom.

(((2))) The image forming apparatus according to (((1))),
wherein the at least one holding member is removably attached to the receiving member in a direction crossing the shaft of the photoconductor.

(((3))) The image forming apparatus according to (((2))),
wherein the at least one holding member is attached to the receiving member from above.

(((4))) The image forming apparatus according to any one of (((1))) to (((3))),
wherein the at least one holding member includes a pair of holding members, and
wherein two ends of the shaft of the photoconductor are respectively held by the pair of holding members.

(((5))) The image forming apparatus according to any one of (((1))) to (((4))),
wherein the at least one holding member is removable from the shaft of the photoconductor.

(((6))) The image forming apparatus according to any one of (((1))) to (((5))),
wherein the receiving member and the at least one holding member include contact surfaces that come into contact with each other.

(((7))) The image forming apparatus according to (((6))),
wherein the receiving member supports the at least one holding member at the contact surfaces.

(((8))) The image forming apparatus according to (((6))) or (((7))),
wherein the receiving member and the at least one holding member are fastened by a fastening member at portions that come into contact with each other.

(((9))) The image forming apparatus according to (((8))),
wherein a fastening direction of the fastening member is a direction parallel to a direction in which the at least one holding member is attached to and removed from the receiving member.

(((10))) The image forming apparatus according to any one of (((1))) to (((9))),
wherein the receiving member includes a protrusion or a recess, and
wherein the at least one holding member includes a recess to which the protrusion of the receiving member fits or a protrusion that fits into the recess of the receiving member.

(((11))) The image forming apparatus according to (((10))),
wherein a direction in which the protrusion and the recess fit is a direction parallel to a direction in which the at least one holding member is attached to and removed from the receiving member.

(((12))) The image forming apparatus according to any one of (((1))) to (((11))),
wherein the handhold is curved in an arc shape.

(((13))) The image forming apparatus according to (((12))),
wherein the handhold has an outer circumference that is curved along an outer circumference of the photoconductor when the photoconductor is viewed in an axial direction.

What is claimed is:

1. An image forming apparatus comprising:
a photoconductor;
at least one holding member including a handhold and rotatably holding a shaft of the photoconductor; and
a receiving member disposed at an apparatus body to allow the at least one holding member to be attachable thereto and removable therefrom.

2. The image forming apparatus according to claim 1,
wherein the at least one holding member is removably attached to the receiving member in a direction crossing the shaft of the photoconductor.

3. The image forming apparatus according to claim 2,
wherein the at least one holding member is attached to the receiving member from above.

4. The image forming apparatus according to claim 1,
wherein the at least one holding member includes a pair of holding members, and
wherein two ends of the shaft of the photoconductor are respectively held by the pair of holding members.

5. The image forming apparatus according to claim 1,
wherein the at least one holding member is removable from the shaft of the photoconductor.

6. The image forming apparatus according to claim 1,
wherein the receiving member and the at least one holding member include contact surfaces that come into contact with each other.

7. The image forming apparatus according to claim 6,
wherein the receiving member supports the at least one holding member at the contact surfaces.

8. The image forming apparatus according to claim 6,
wherein the receiving member and the at least one holding member are fastened by a fastening member at portions that come into contact with each other.

9. The image forming apparatus according to claim 8,
wherein a fastening direction of the fastening member is a direction parallel to a direction in which the at least one holding member is attached to and removed from the receiving member.

10. The image forming apparatus according to claim 1,
wherein the receiving member includes a protrusion or a recess, and
wherein the at least one holding member includes a recess to which the protrusion of the receiving member fits or a protrusion that fits into the recess of the receiving member.

11. The image forming apparatus according to claim 10,
wherein a direction in which the protrusion and the recess fit is a direction parallel to a direction in which the at least one holding member is attached to and removed from the receiving member.

12. The image forming apparatus according to claim 1,
wherein the handhold is curved in an arc shape.

13. The image forming apparatus according to claim 12,
wherein the handhold has an outer circumference that is curved along an outer circumference of the photoconductor when the photoconductor is viewed in an axial direction.
